(19) United States
(12) Patent Application Publication
(10) Pub. No.: US 2002/0054247 A1
(43) Pub. Date: May 9, 2002

(54) Method for fabricating an array substrate of a liquid crystal display device

(75) Inventors: Kwang-Jo Hwang, Gyeonggi-do (KR); Hyun-Sik Seo, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 09/985,665

(22) Filed: Nov. 5, 2001

(30) Foreign Application Priority Data
Nov. 7, 2000 (KR) 2000-65874

(51) Int. Cl. G02F 1/136

(52) U.S. Cl. 349/43

(57) ABSTRACT

A method for fabricating an array substrate of a liquid crystal display device includes forming a gate line and a gate electrode connected to the gate line, forming a gate insulating layer, an amorphous silicon layer, a doped amorphous silicon layer and a metal layer on the gate line and the gate electrode, forming a data line, a source electrode, a drain electrode, an ohmic contact layer and an active layer by patterning the metal layer, the doped amorphous silicon layer and the amorphous silicon layer with a single photolithographic masking step, forming a passivation layer covering the data line, and the source and drain electrodes, the passivation layer having a contact hole exposing a portion of the drain electrode, and forming a pixel electrode connected to the drain electrode through the contact hole.

This application claims the benefit of Korean Patent Application No. 2000-65874, filed Nov. 7, 2000 in Korea, which is hereby incorporated by reference.

### BACKGROUND OF THE INVENTION

1. Field of the Invention

The present invention relates to an active-matrix liquid crystal display (AM LCD) device and a method of fabricating the same, and more particularly, to a method of fabricating the array substrate of a liquid crystal display device. Although the present invention is suitable for a wide scope of applications, it is particularly suitable for improving a four-mask process resulting in a reduction of a fabrication cost of the LCD device.

2. Discussion of the Related Art

Generally, a liquid crystal display (LCD) device includes an upper substrate, a lower substrate, and liquid crystal layer interposed therebetween. The upper and lower substrates each have electrodes opposing each other. When an electric field is applied between the electrodes of the upper and lower substrates, molecules of the liquid crystal layer are aligned according to the applied electric field. By controlling the applied electric field, the liquid crystal display device provides various light transmittances to display images.

Presently, active matrix LCD (AM LCD) devices are one of the most popular means for displaying images because of their high resolution and superiority in displaying moving images. A typical AM-LCD device has a plurality of switching elements and pixel electrodes that are arranged in an array matrix on the lower substrate. Accordingly, the lower substrate of the AM LCD device is alternatively referred to as an array substrate. On the upper substrate of the AM LCD device, a common electrode made of a transparent conductive material is regularly formed. In the case of a color LCD device, a color filter is further formed between the upper substrate and the common electrode of the upper substrate.

The above-described lower and upper substrates are attached together using a sealant formed therebetween. Then, a liquid crystal layer is interposed into a cell gap formed between the lower and upper substrates. Accordingly, since the pixel and common electrodes are disposed on the lower and upper substrates, respectively, the electric field induced therebetween is perpendicular to the lower and upper substrates. The resulting liquid crystal display device has a high transmittance and a high aperture ratio. In addition, since the common electrode disposed on the upper substrate serves as an electrical ground, damage to the liquid crystal display device from electrostatic discharge is eliminated. Furthermore, the upper substrate includes a black matrix disposed at various intervals, thereby preventing leakage of light and the display of abnormal images.

Conventionally, fabrication of an array substrate for an LCD device includes five or six masks implemented in mask step processing. Accordingly, since the mask step processing includes a plurality of sub-steps including cleaning, depositing, baking, etching, for example, if a single mask step can be reduced, fabrication time and production costs can be greatly decreased. Therefore, decreasing the total number of masks to four is highly desirable in fabrication of LCD devices.

Among different methods for fabricating an array substrate using only 4 masks, there is a method to form a data line, a source electrode, a drain electrode and an active layer with a single photolithographic masking step using a slit-formed mask. The method will be explained in detail with reference to the FIGS. 1A to 1E.

As shown in FIG. 1A, a gate electrode 22, a gate insulating layer 30, an amorphous silicon layer 40, a doped amorphous silicon layer 50 and a metal layer 60 are sequentially formed on an insulating substrate 10. Thereafter, a photoresist layer 90 is formed on the metal layer 60 with a thickness under 3 μm. A light shielding portion 101 is formed in a bottom portion of a mask 100 corresponding to regions “A” where a data line (not shown), and source and drain electrodes (not shown) are to be formed. Slits are formed in a portion of the mask 100 corresponding to region “C” where a TFT channel is to be formed, whereby light exposure is performed through the slits. Then, the photoresist layer 90 is exposed to light via the mask 100. A portion of the photoresist layer 90 positioned under the light shielding portion 101 is shielded from the light and a portion of the photoresist layer 90 positioned in the channel region “C” is partly exposed to the light because intensity of the light is diminished as a result of diffraction of the light passing through the slits. Accordingly, remaining portions of the photoresist layer 90 are exposed to the light via regions “B.”

In FIG. 1B, the photoresist layer patterns 91, 92 are formed by developing the exposed portions of the photoresist layer 90. In regions “A,” where the data line and the source and drain electrodes are to be formed, the photoresist layer pattern 91 has a first thickness. In region “C,” where the TFT is to be formed, the photoresist layer pattern 92 has a second thickness which is thinner than the first thickness. In regions “B,” the photoresist is completely removed.

In FIG. 1 C, an active layer pattern 41, a doped amorphous silicon layer pattern 55 and a metal layer pattern 65 are formed by etching the amorphous silicon layer 40, doped amorphous silicon layer 50 and metal layer 60, respectively.

In FIG. 1D, the photoresist layer pattern 92 where a TFT channel is to be formed is removed by an ashing process using an oxygen plasma. Accordingly, an upper part of the photoresist layer patterns 91 having the first thickness are partially removed, thereby reducing the thickness of the photoresist layer patterns 91.

In FIG. 1E, the data line, the source and drain electrodes 62,63, and ohmic contact layers 51 and 52 are formed by removing portions of the metal layer pattern 65 and the doped amorphous silicon layer pattern 55 within the TFT channel region.

In the above-described method, the thickness of the photoresist layer 90 is varied using the slit-formed mask. The thickness of the photoresist layer pattern 92 must be controlled to expose the upper part of the channel. As described above, the first thickness of the photoresist layer patterns 91 is reduced during the ashing process that completely removes the photoresist layer pattern 92. Therefore, if the second thickness of the photoresist layer pattern 92 is too large, a line width of the source and drain electrodes can be reduced. Accordingly, the thickness of the photoresist layer pattern 92 is under about 5,000 Å (angstrom). Moreover, the thickness of the photoresist layer pattern 92 is dependent upon the intensity of light that is exposed on the photoresist layer 90 that corresponds to the channel region. Therefore, the thickness of the photoresist layer pattern 92 can be controlled by varying a clearance between slits of mask (in FIG. 1A).

### SUMMARY OF THE INVENTION

Accordingly, the present invention is directed to a fabricating method for an array substrate of a liquid crystal display device that substantially obviates one or more of problems due to limitations and disadvantages of the related art.

An object of the present invention is to provide a fabricating method for the array substrate of the liquid crystal display by which a fabricating process can be simplified without making an alteration to an apparatus used for the masking process.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for fabricating an array substrate of a liquid crystal display device includes forming a gate line and a gate electrode connected to the gate line, forming a gate insulating layer, an amorphous silicon layer, a doped amorphous silicon layer and a metal layer on the gate line and the gate electrode, forming a data line, a source electrode, a drain electrode, an ohmic contact layer and an active layer by patterning the metal layer, the doped amorphous silicon layer and the amorphous silicon layer with a single photolithographic masking step, forming a passivation layer covering the data line, and the source and drain electrodes, the passivation layer having a contact hole exposing a portion of the drain electrode, and forming a pixel electrode connected to the drain electrode through the contact hole.

In another aspect, a method for fabricating an array substrate of a liquid crystal display device includes forming a gate line and a gate electrode on a transparent substrate using a first mask, forming a gate insulating layer on the gate line and the gate electrode, forming a data line, a source electrode, a drain electrode, ohmic contact layers, and an active layer on the gate insulating layer by exposing a photoresist layer having a thickness less than about 3 μm via a second mask, forming a passivation layer on at least the source and drain electrodes, the active layer and the gate insulating layer using a third mask, the passivation layer having a contact hole exposing a portion of the drain electrode, forming a pixel electrode on at least the exposed portion of the drain electrode and the passivation layer using a fourth mask.

In another aspect, a photoresist layer pattern for forming an array substrate of a liquid crystal display device includes a first portion of photoresist layer pattern having a first thickness disposed over a source and drain electrode formation region of the array substrate, and a second portion of photoresist layer pattern having a second thickness less than the first thickness disposed over a channel formation region of the array substrate, wherein the second thickness is less than about 5,000 Å.

In another aspect, a method for fabricating an array substrate of a liquid crystal display device includes forming a gate line and a gate electrode on a transparent substrate, forming a gate insulating layer on the gate line and the gate electrode, forming an amorphous silicon layer, a doped amorphous silicon layer, and a metal layer on the gate insulating layer, forming a photoresist layer pattern including a first portion and second portions on the metal layer, the second portion having a thickness less than about 5,000 Å disposed directly above the gate electrode and the first portion disposed laterally adjacent to the second portion, forming a source electrode, a drain electrode, ohmic contact layers, and an active layer, forming a passivation layer on at least the source and drain electrodes, the active layer and the gate insulating layer, the passivation layer having a contact hole exposing a portion of the drain electrode, forming a pixel electrode on at least the exposed portion of the drain electrode and the passivation layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1A to 1E are cross-sectional views illustrating a sequence of fabricating an array substrate of a liquid crystal display device according to the related art;

FIG. 2 is a plan view illustrating a part of an exemplary array substrate of a liquid crystal display device according to the present invention;

FIG. 3 is a cross-sectional view taken along III-III of FIG. 2; and

FIGS. 4A to 4G are cross-sectional views illustrating an exemplary sequence of fabricating an array substrate of a liquid crystal display device according to the present invention.

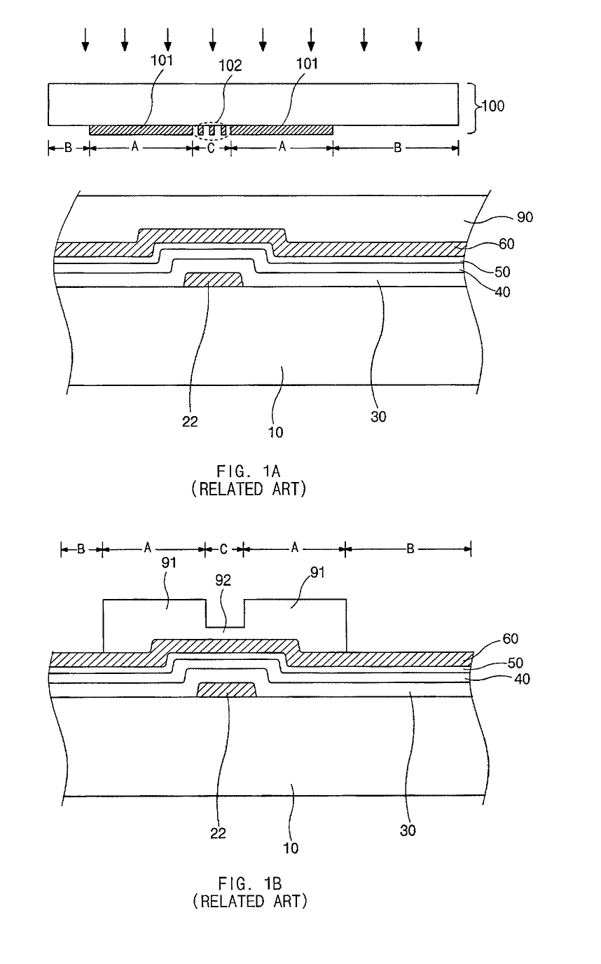

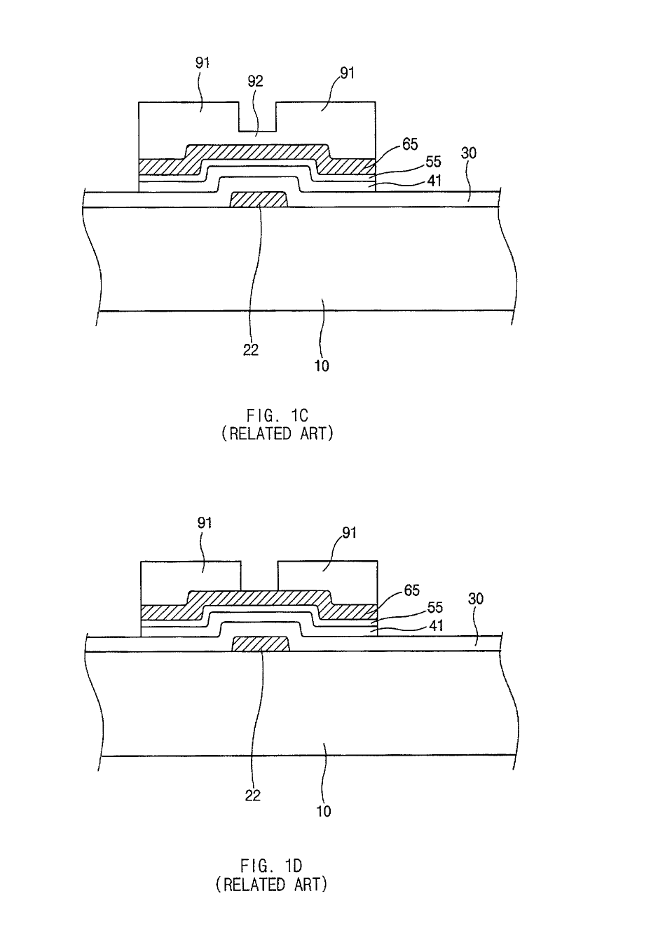

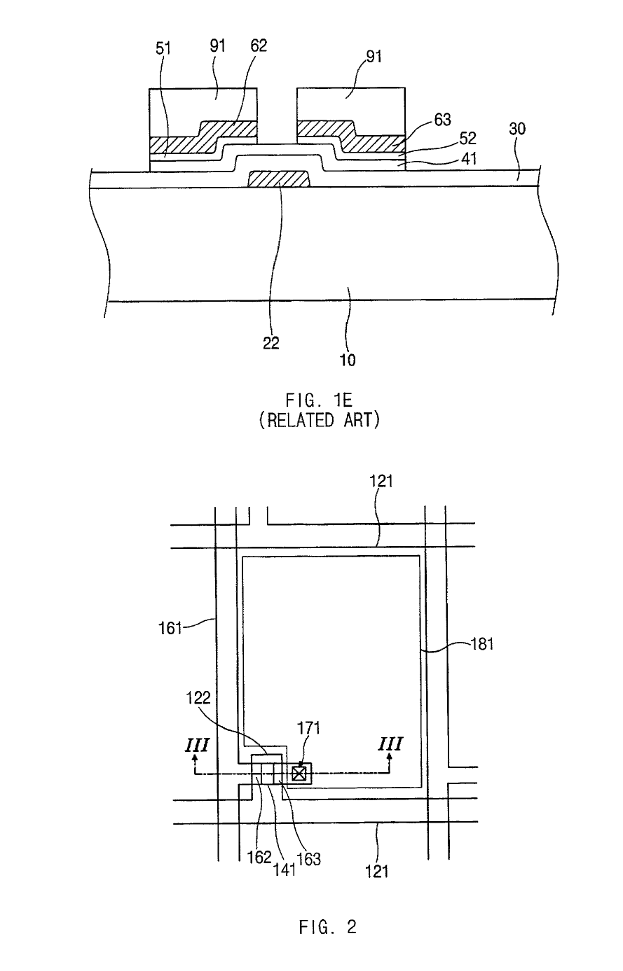

### DETAILED DESCRIPTION OF THE PREFERRED EMBODIMENTS

Reference will now be made in detail to the preferred embodiment of the present invention, which is illustrated in the accompanying drawings.

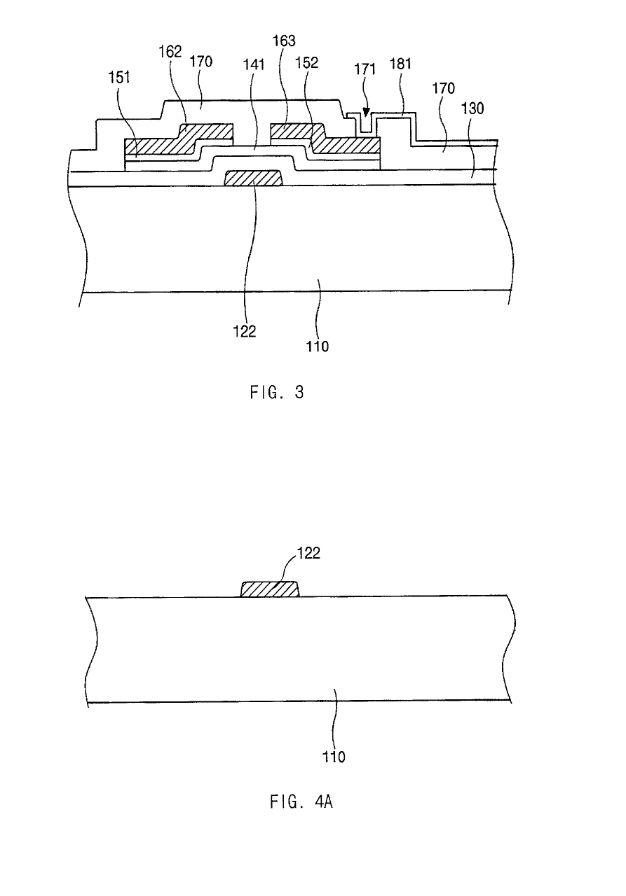

FIG. 2 is a plan view illustrating a part of an exemplary array substrate of a liquid crystal display device according to the present invention and FIG. 3 is a cross-sectional view taken along III-III of FIG. 2.

In FIGS. 2 and 3, a gate line 121 and a gate electrode 122 may be formed on a substrate 110. A gate insulating layer 130 may be formed over the gate line 121 to cover the gate line 121 and the gate electrode 122. An active layer 141 and ohmic contact layers 151 and 152 may be sequentially formed on the gate insulating layer 130. A data line 161 that crosses the gate line 121, a source electrode 162 that is connected to the data line 161, and a drain electrode 163 that is spaced apart from the source electrode 162 may be formed on the ohmic contact layers 151 and 152. Moreover, the ohmic contact layers 151 and 152 may have a same, or similar shape as shapes of the data line 161, the source and drain electrodes 162 and 163. Likewise, the active layer 141 may have a same, or similar shape as the shapes of the data line 161 and the source and drain electrodes 162 and 163, except for a portion of the active layer 141 that corresponds to the channel region. A passivation layer 170 may be formed on the data line 161 and the source and drain electrodes 162 and 163. The passivation layer 170 may include a contact hole 171 formed over the drain electrode 163. A pixel electrode 181 formed of a transparent conductive material, for example, may be formed in a pixel region defined by a crossing of the gate line 121 with the data line 161. The pixel electrode 181 may be connected to the drain electrode 163 through the contact hole 171.

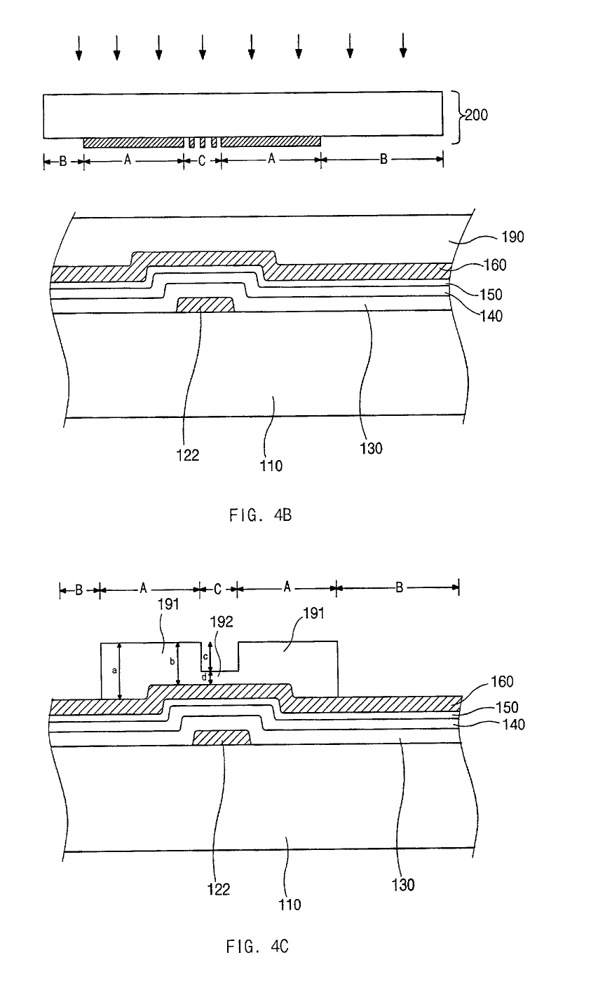

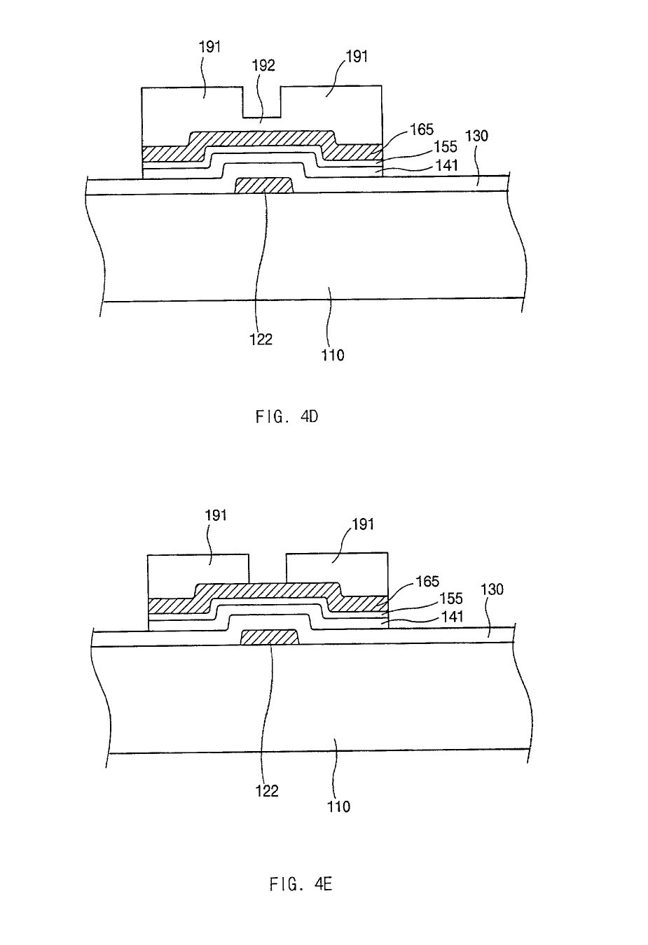

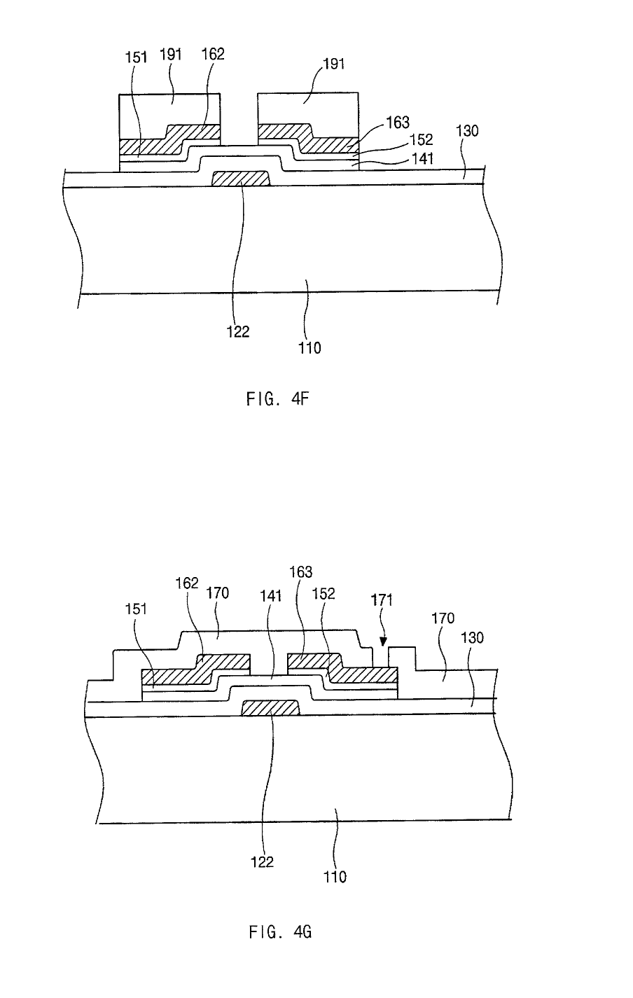

An exemplary fabricating sequence of the exemplary array substrate of a liquid crystal display device according to the present invention will be explained with reference to FIG. 3 and FIGS. 4A to 4G.

In FIG. 4A, the gate line 121 and the gate electrode 122 may be formed on the transparent substrate 110 using a first mask.

In FIG. 4B, the gate insulating layer 130, the amorphous silicon layer 140 and the doped amorphous silicon layer 150 may be sequentially deposited on the gate line 121, the gate electrode 122 and the transparent substrate 110. The metal layer 160 may be deposited on the doped amorphous silicon layer 150 by sputtering, for example. The photoresist layer 190 may be coated on the metal layer 160 to a thickness of less than about 3 μm. Light shielding portions may be formed on a bottom portion of a second mask 200 that corresponds to the region “A,” where the data line (not shown) and the source and drain electrodes (not shown) are to be formed. Slits may be formed on a bottom portion of the second mask 200 that corresponds to the region “C,” where the TFT channel is to be formed. Subsequently, light may be exposed through the second mask 200 onto portions of the photoresist layer 190.

In FIG. 4C, photoresist layer patterns 191 and 192 may be formed by developing the photoresist layer 190. In region “A,” the photoresist layer patterns 191 are formed having a first thickness. In region “C,” the photoresist layer pattern 192 is formed having a second thickness that is smaller than the first thickness. In regions “B,” the photoresist layer may be totally eliminated. It is desirable to control the second thickness of the photoresist layer pattern 192 to be under about 5,000 Å (angstrom) in order to protect a reduction of line width of the source and drain electrodes. As shown in FIG. 4C, a thickness of a portion of the photoresist layer pattern 191 is thickness “a,” a thickness of a portion of the photoresist layer pattern 191 reduced by a thickness of the gate electrode 122 is thickness “b,” a thickness of the removed portion of the photoresist layer pattern 192 after developing is thickness “c,” and a thickness of the photoresist layer pattern 192 that remains in the region “C” where the channel is to be formed, is thickness “d,” which can be determined by the difference between thicknesses “b” and “c.” Accordingly, thickness “d” may be determined by thickness “b,” and thickness “b” is dependent upon a thickness of the gate electrode 122. Therefore, thickness “d” can be reduced by increasing the thickness of the gate electrode 122 since increasing the thickness of the gate electrode results in a reduction of thickness “b.” When a thickness of the photoresist layer 190 (in FIG. 4B) is smaller than about 3 μm, it is desirable for thickness “d” to be under about 5,000 Å. Furthermore, if the thickness of the gate electrode 122 is smaller than about 2,000 Å, thickness “b” increases due to a small step height of the gate electrode. Thus, thickness “d” increases to over about 5,000 Å. In contrast, if the thickness of the gate electrode 122 is over about 5,000 Å, the gate insulating layer 130 can be severed at the stepped portions of the gate electrode 122. Therefore, it is desirable to form the gate electrode 122 with a thickness between about 2,000 and about 5,000 Å. Furthermore, a total number and period spacing of the slits formed in region “C” of the second mask 200 may be determined in accordance with a desired thickness of the photoresist layer pattern 192.

In FIG. 4D, an active layer pattern 141, a doped amorphous silicon layer pattern 155, and a metal layer pattern 165 may be formed by etching away the amorphous silicon layer 140, the doped amorphous silicon layer 150, and the metal layer 160, respectively.

In FIG. 4E, the photoresist layer pattern 192 disposed in the channel region may be removed by an ashing process using an oxygen plasma, for example.

In FIG. 4F, the data line 161(not shown), the source and drain electrodes 162 and 163, and the ohmic contact layers 151 and 152 may be formed by removing portions of the metal layer pattern 165 and the doped amorphous silicon layer pattern 155 in the TFT channel region.

In FIG. 4G, a passivation layer 170 may be formed by depositing silicon oxide (SiO₂) or silicon nitride (SiN_{X}), for example. The passivation layer 170 may include a contact hole 171, which exposes a portion of the drain electrode 163, formed by a photolithographic masking step that uses a third mask.

Subsequently, as shown in FIG. 3, a transparent conductive material such as indium tin oxide (ITO), for example, may be deposited on the passivation layer 170 and patterned to form a pixel electrode 181 by a photolithographic masking step using a fourth mask. The pixel electrode 181 is connected to the drain electrode 163 through the contact hole 171.

As described above, the array substrate of the liquid crystal display device can be fabricated using 4 masking steps without making an alteration to the apparatus used for the masking process.

It will be apparent to those skilled in the art that various modifications and variation can be made in the method of fabricating an array substrate of the present invention without departing from the spirit or scope of the invention. Thus, it is intended that the present invention cover the modifications and variations of this invention provided they come within the scope of the appended claims and their equivalents.

What is claimed is:

1. A method for fabricating an array substrate of a liquid crystal display device, comprising:
forming a gate line and a gate electrode connected to the gate line;
forming a gate insulating layer, an amorphous silicon layer, a doped amorphous silicon layer and a metal layer on the gate line and the gate electrode;
forming a data line, a source electrode, a drain electrode, an ohmic contact layer and an active layer by patterning the metal layer, the doped amorphous silicon layer and the amorphous silicon layer with a single photolithographic masking step;
forming a passivation layer covering the data line, and the source and drain electrodes, the passivation layer having a contact hole exposing a portion of the drain electrode; and
forming a pixel electrode connected to the drain electrode through the contact hole.

2. The method according to claim 1, wherein the forming of a data line, a source electrode, a drain electrode, an ohmic contact layer and an active layer includes coating a photoresist layer on the metal layer to a thickness less than about 3 μm.

3. The method according to claim 2, wherein the coating of a photoresist layer includes forming a photoresist layer pattern by exposing and developing the photoresist layer.

4. The method according to claim 3, wherein the photoresist layer pattern includes at least a first portion having a first thickness located over a region where the data line and the source electrode and the drain electrodes are to be formed and at least a second portion having a second thickness located over a channel region where a thin film transistor channel is to be formed.

5. The method according to claim 4, wherein a thickness of the gate electrode is between about 2,000 Å and about 5,000 Å and the second thickness of the second portion of the photoresist layer pattern is less than about 5,000 Å.

6. The method according to claim 4, wherein exposing the photoresist layer includes a mask having a plurality of slits disposed on a portion of the mask corresponding to the channel region.

7. A method for fabricating an array substrate of a liquid crystal display device, comprising:
forming a gate line and a gate electrode on a transparent substrate using a first mask;
forming a gate insulating layer on the gate line and the gate electrode;
forming a data line, a source electrode, a drain electrode, ohmic contact layers, and an active layer on the gate insulating layer by exposing a photoresist layer having a thickness less than about 3 μm via a second mask;
forming a passivation layer on at least the source and drain electrodes, the active layer and the gate insulating layer using a third mask, the passivation layer having a contact hole exposing a portion of the drain electrode;
forming a pixel electrode on at least the exposed portion of the drain electrode and the passivation layer using a fourth mask.

8. The method according to claim 7, wherein the second mask includes a plurality of slits disposed in a region corresponding to a channel region of the active layer.

9. The method according to claim 8, wherein the second mask further includes light shielding portions corresponding to the source and drain electrodes.

10. The method according to claim 7, further includes developing the exposed portions of the photoresist layer to form at least a channel region portion, source a nd drain electrodes portions, and a data line portion.

11. The method according to claim 10, wherein a thickness of a photoresist layer pattern corresponding to the channel region is less than about 5,000 Å.

12. A photoresist layer pattern for forming an array substrate of a liquid crystal display device, comprising:
a first portion of a photoresist layer pattern having a first thickness disposed over a source and drain electrode formation region of the array substrate; and
a second portion of the photoresist layer pattern having a second thickness less than the first thickness disposed over a channel formation region of the array substrate, wherein the second thickness is less than about 5,000 Å.

13. The photoresist layer pattern according to claim 12, wherein the second thickness is smaller than the first thickness

14. The photoresist layer pattern according to claim 12, wherein an upper surface of each of the first and second portion of the photoresist layer pattern is planar.

15. A method for fabricating an array substrate of a liquid crystal display device, comprising:
forming a gate line and a gate electrode on a transparent substrate;
forming a gate insulating layer on the gate line and the gate electrode;
forming an amorphous silicon layer, a doped amorphous silicon layer, and a metal layer on the gate insulating layer;
forming a photoresist layer pattern including a first portion and second portion on the metal layer, the second portion having a thickness less than about 5,000 Å disposed directly above the gate electrode and the first portion disposed laterally adjacent to the first portion;
forming a source electrode, a drain electrode, ohmic contact layers, and an active layer;
forming a passivation layer on at least the source and drain electrodes, the active layer and the gate insulating layer, the passivation layer having a contact hole exposing a portion of the drain electrode;
forming a pixel electrode on at least the exposed portion of the drain electrode and the passivation layer.

16. The method according to claim 15, wherein the forming of the source electrode, drain electrode, ohmic contact layers, and active layer includes patterning the photoresist layer.

17. The method according to claim 18, further comprising ashing the photoresist layer using an oxygen plasma.
